(19) United States
(12) Patent Application Publication
(10) Pub. No.: US 2012/0037115 A1
(43) Pub. Date: Feb. 16, 2012

(54) METHOD FOR THE PRODUCTION OF A PISTON FOR AN INTERNAL COMBUSTION ENGINE AND PISTON FOR AN INTERNAL COMBUSTION ENGINE

(75) Inventors: Frank SCHNAITER, Ditzingen (DE); Karlheinz BING, Remseck (DE); Rainer SCHARP, Vaihingen (DE)

(73) Assignee: MAHLE INTERNATIONAL GMBH, Stuttgart (DE)

(21) Appl. No.: 13/206,089

(22) Filed: Aug. 9, 2011

(30) Foreign Application Priority Data
Aug. 10, 2010 (DE) 10 2010 033 879.6

(51) Int. Cl. F02F 3/28; B23K 13/01; H05B 6/10; B21K 1/18

(52) U.S. Cl. 123/193.6; 29/888.044; 219/617; 219/635

(57) ABSTRACT

A method for the production of a piston for an internal combustion engine has the following steps: producing an upper piston part having at least one joining surface, b) producing a lower piston part having at least one joining surface, c) producing a direct contact between the at least one joining surface of the upper piston part and the at least one joining surface of the lower piston part, d) heating the upper piston part and the lower piston part by induction or by a direct flow of current over the joining surfaces in the region of the joining surfaces that have been brought into direct contact, e) connecting the upper and lower piston parts with one another to produce a piston by a pressing process, and machining the piston to finish it.

### CROSS REFERENCE TO RELATED APPLICATIONS

Applicants claim priority under 35 U.S.C. §119 of German Application No. 10 2010 033 879.6 filed Aug. 10, 2010, the disclosure of which is incorporated by reference.

### BACKGROUND OF THE INVENTION

1. Field of the Invention

The present invention relates to a method for the production of a piston for an internal combustion engine.

2. The Prior Art

Such a method is described, for example, in U.S. Pat. No. 6,825,450 B2. An upper piston part and a lower piston part are connected with one another by induction welding, whereby an induction coil is positioned between the joining surfaces of the upper piston part and lower piston part. After the joining surfaces are heated, the induction coil is removed and the weld connection is produced.

In this method, however, the joining surfaces cool off after the induction coil is removed, so that no optimal weld connection is achieved. Furthermore, in this method, the work has to be performed under an inert gas atmosphere, in order to prevent the heated joining surfaces from being impaired or detrimentally changed by reaction with oxygen in the air.

### SUMMARY OF THE INVENTION

It is therefore an object of the present invention to provide a method for the production of a piston for an internal combustion engine, in which an improved weld connection is achieved in the simplest possible manner.

This object is achieved by a method having the following steps:

a) an upper piston part having at least one joining surface is produced,

b) a lower piston part having at least one joining surface is produced,

c) a direct contact between the at least one joining surface of the upper piston part and the at least one joining surface of the lower piston part is produced,

d) the upper piston part and the lower piston part are heated by induction or by a direct flow of current over the joining surfaces in the region of the joining surfaces that have been brought into direct contact, and

e) the upper piston part and the lower piston part are connected with one another to produce a piston, by means of a pressing process.

According to the invention, a direct contact between the joining surfaces of upper piston part and lower piston part is therefore produced, before heating is undertaken in the region of the joining surfaces, in order to connect the two components with one another in the region of their heated joining surfaces. Cooling of the joining surfaces before connecting upper piston part and lower piston part is thereby avoided, so that the resulting weld connection is qualitatively improved as compared with the state of the art. Furthermore, it is possible to eliminate the need for an inert gas atmosphere, since the heated joining surfaces do not come into contact with the ambient air. The joining surfaces are heated either inductively, i.e. by means of induced eddy currents, or by means of direct current flow, and subsequently connected with one another by a pressing process, i.e. by means of the action of mechanical force. The piston can be machined to finish it, if necessary.

An object of the present invention is furthermore a piston that can be produced according to the method according to the invention.

Finally, an object of the present invention is a piston for an internal combustion engine, having an upper piston part and a lower piston part. The upper piston part has a combustion bowl as well as an inner and an outer joining surface and the lower piston part has an inner and an outer joining surface. The upper piston part and lower piston part form a circumferential cooling channel and the inner joining surfaces have a predetermined width a. The inner joining surface of the lower piston part is formed by a circumferential support element, which has the axial length b, with b≧1.5*a. A circumferential constriction on the cooling channel side having a depth c, with c≦0.8*a is provided below the circumferential support element.

According to the invention, it is therefore provided that the circumferential wall of the combustion bowl, which separates the combustion bowl from the circumferential cooling channel, has a predetermined thickness that results from a predetermined width a of the inner joining surfaces of upper piston part and lower piston part. The inner joining surface of the lower piston part is formed by a circumferential support element of the lower piston part, the axial length b of which amounts to at least one and a half times the width a of the inner support surfaces of lower piston part and upper piston part. Below the circumferential support element of the lower piston part, a circumferential constriction on the cooling channel side is furthermore provided, the depth c of which amounts to at most 0.8 times the width a of the support surfaces of lower piston part and upper piston part.

The width a depends on the size and the dimensions of the piston in an individual case. It is essential that the length b of the support element and the depth c of the constriction are dimensioned as a function of the width a of the support surfaces. This structure represents an optimal compromise between the demands concerning the stability of the piston and the need to dimension the support surfaces to be welded so as to be rather small, in order to optimize the inflow and outflow of heat and pressure during the welding process. With the configuration according to the invention, the result is achieved that the circumferential wall of the combustion bowl does not give way during the welding process, so that when the contact pressure is taken away, no cracks occur in the weld seam. Furthermore, the configuration according to the invention brings about the result that in engine operation, the ignition pressure and the ignition heat are passed into the lower piston regions particularly well.

In a preferred embodiment of the method according to the invention, a narrowing is provided in the region of the at least one joining surface of the upper piston part and/or of the at least one joining surface of the lower piston part. This narrowing is filled up, in step e), with the material of the upper piston part or lower piston part, respectively, preferably to the nominal cross-section of the joining surfaces. In this way, the formation of a bead along the weld seam is avoided in an advantageous manner. The narrowing can be configured as a groove, notch, or constriction, for example.

Steps d) and/or e) can be carried out, in a particularly advantageous manner, in an ambient atmosphere, i.e. it is possible to do without inert gas or the introduction of the components into a vacuum before heating the joining surfaces. In this way, the method according to the invention is further simplified.

In step e), the pressing process can preferably be combined with a rotation process, i.e. the upper piston part and lower piston part are rotated relative to one another, for example by a few degrees of angle, in order to further strengthen the weld connection.

Another preferred further development of the method according to the invention provides that the upper piston part has a combustion bowl as well as an inner and an outer joining surface, the lower piston part has an inner and an outer joining surface, and a circumferential cooling channel is formed when upper piston part and lower piston part are connected. Thus, a cooling channel piston can be produced in a particularly simple manner. Since the joining surfaces of the upper piston part are accessible, either from the outer surface of the upper piston part or from the combustion bowl, the method according to the invention is well suited for the production of such cooling channel pistons.

In this connection, the method according to the invention allows, in an advantageous manner, the modifications that the inner and outer joining surfaces of upper piston part and lower piston part are disposed in the same plane or that the joining surfaces of upper piston part and lower piston part are disposed in at least two different planes. An offset of the joining surfaces therefore does not represent a problem.

The upper piston part and/or the lower piston part can be cast parts or forged parts, for example, and can be produced from a steel material or a cast iron material, for example.

It is advantageous if the constriction extends all the way to the bottom of the cooling channel, in order to further optimize carrying away heat and pressure, taking the material volume into consideration.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a section through a first embodiment of a piston according to the invention, before welding;

FIG. 2 shows the piston according to FIG. 1 in section, rotated by 90° as compared with FIG. 1;

FIG. 3 shows the piston according to FIG. 1 after welding;

FIG. 4 shows the piston according to FIG. 3 in section, rotated by 90° as compared with FIG. 3;

FIG. 5 shows a section through another exemplary embodiment of a piston according to the invention, before welding;

FIG. 6 shows the piston according to FIG. 5 in section, whereby the representation is rotated by 90° as compared with FIG. 5;

FIG. 7 shows the piston according to FIG. 5 after welding;

FIG. 8 shows the piston according to FIG. 7 in section, rotated by 90° as compared with FIG. 7;

FIG. 9 shows a section through another embodiment of a piston according to the invention; and

FIG. 10 shows an enlarged partial view of the piston according to FIG. 9.

### DETAILED DESCRIPTION OF THE PREFERRED EMBODIMENT

Referring now in detail to the drawings, FIGS. 1 to 4 show a first exemplary embodiment of a method according to the invention, using a piston 10. The piston 10 is a two-part box piston, having a circumferential cooling channel. However, the present invention is also suitable for other piston types, of course.

The piston 10 is composed of an upper piston part 11 and a lower piston part 12, which can be produced, for example, from a steel material or a cast iron material, for example by casting or forging. The piston 10 has a piston crown 13 having a combustion bowl 14. Piston crown 13 and combustion bowl 14 are formed partly by the upper piston part 11 and partly by the lower piston part 12. The top land and ring grooves along the outer wall region 18 are not shown, for the sake of clarity. The lower piston part 12 has a piston skirt 15 and pin bosses 16 with pin bores 17 for accommodating a piston pin (not shown).

The upper piston part 11 has an inner joining surface 21 and an outer joining surface 22. The inner joining surface 21 is configured in a ring-shaped, circumferential manner in the region of the combustion bowl 14. The outer joining surface 22 is configured below the wall region 18.

The lower piston part 12 also has an inner joining surface 23 and an outer joining surface 24. The inner joining surface 23 is configured in a ring-shaped, circumferential manner, corresponding to the inner joining surface 22 of the upper piston part 11, in the region of the combustion bowl 14. In the exemplary embodiment, the outer joining surface 14 is configured as an extension of the piston skirt 15. The inner joining surfaces 21, 23 of the upper piston part 11 and of the lower piston part 12, respectively, are disposed offset from the outer joining surfaces 22, 24 of the upper piston part 11 and of the lower piston part 12, respectively. The upper piston part 11 and the lower piston part 12 form a circumferential cooling channel 25.

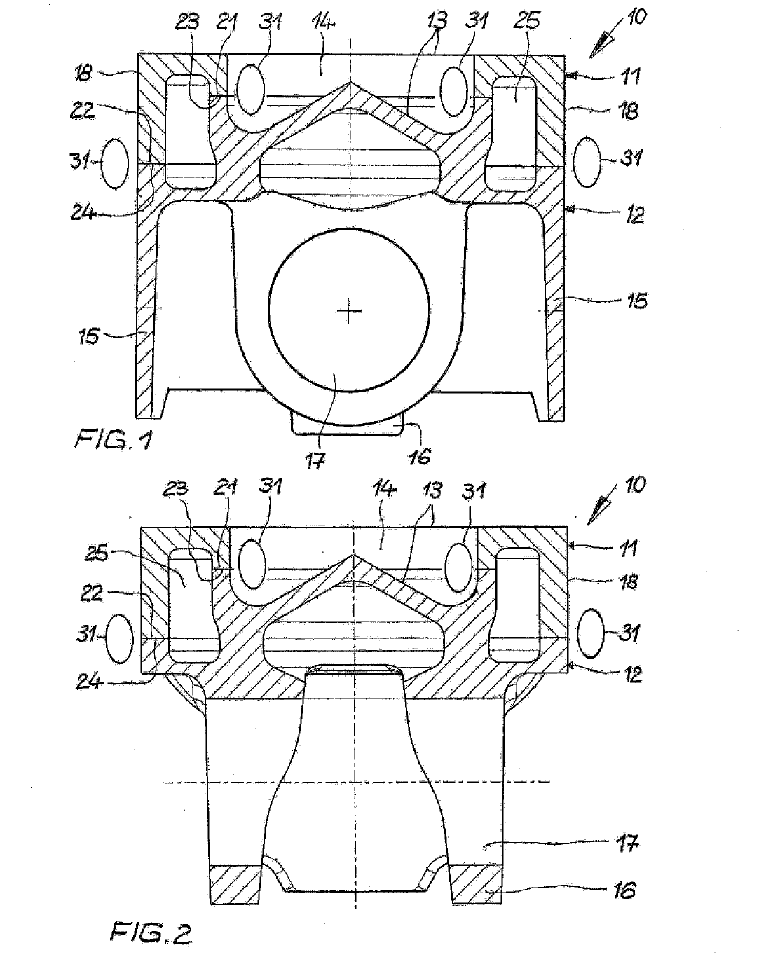

The piston 10 is produced from the upper piston part 11 and the lower piston part 12 as follows. First, as is evident from FIGS. 1 and 2, a direct contact is produced between the corresponding inner joining surfaces 21, 23 of the upper piston part 11 and of the lower piston part 12, respectively, as well as between the outer joining surfaces 22, 24 of the upper piston part 11 and of the lower piston part 12, respectively. The inner joining surfaces 21, 22 and the outer joining surfaces 23, 24, respectively, therefore lie directly on top of one another. An induction coil 31 is positioned in the region of the combustion bowl 14 and assigned to the inner joining surfaces 21, 23 of upper piston part 11 and lower piston part 12. A further induction coil 32 is positioned in the region of the outer wall 18 and assigned to the outer joining surfaces 22, 24 of upper piston part 11 and lower piston part 12, respectively. The upper piston part 11 and the lower piston part 12 are heated by induction in the region of their joining surfaces 21, 23 and 22, 24, respectively, until the material in this region becomes plastically deformable. Then, upper piston part 11 and lower piston part 12 are connected with one another by a pressing process, whereby upper piston part 11 and lower piston part 12 can be rotated by a few degrees of angle relative to one another.

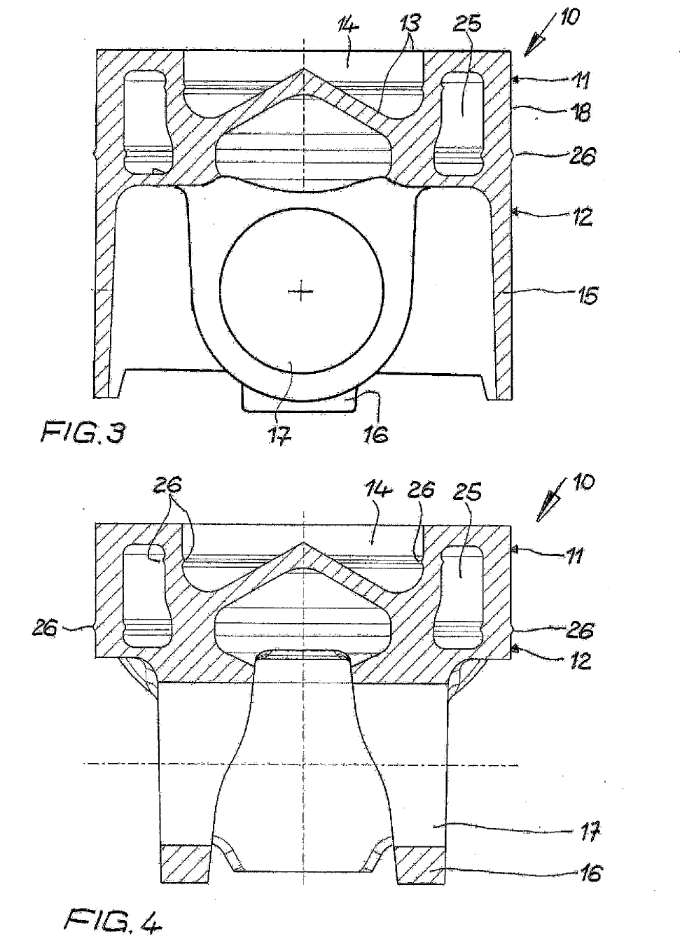

FIGS. 3 and 4 show the piston 10 obtained after upper piston part 11 and lower piston part 12 are connected. Small circumferential beads 26 are formed along the weld seams, which beads have been formed from material exiting at the sides during the pressing process when upper piston part 11 and lower piston part 12 were connected. The piston 10 can be machined further, particularly by introducing ring grooves and removing the beads 26, which are accessible from the outside.

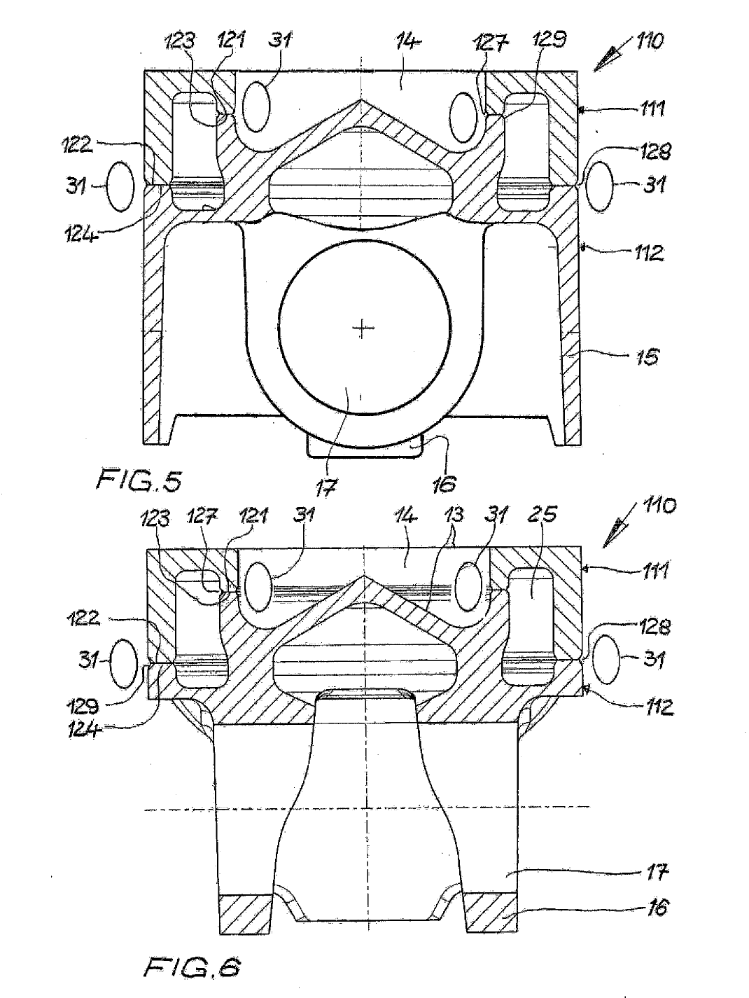

FIGS. 5 to 8 show another exemplary embodiment of a method according to the invention, using a piston 110 composed of an upper piston part 111 and a lower piston part 112. The piston 110 is almost identical with the piston 10 according to FIGS. 1 to 4, so that the same reference symbols were used for identical structures, and are used to the description relating to FIGS. 1 to 4.

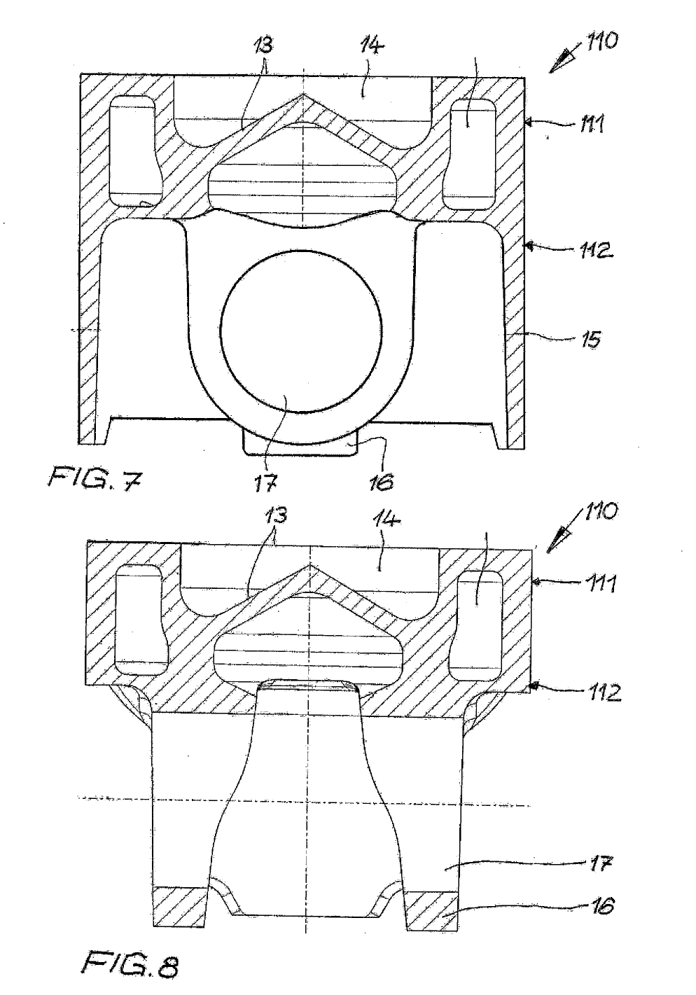

The significant difference between the piston 10 according to FIGS. 1 to 4 and the piston 110 according to FIGS. 5 to 8 as well as between the methods according to the invention used for their production consists in that the upper piston part 111 and the lower piston part 112 have narrowings 127, 128 in the region of the joining surfaces 121, 123 and 122, 124, respectively, in the assembled but not yet welded state. In the exemplary embodiment, the narrowings 127, 128 are configured as constrictions, and are produced, in the exemplary embodiment, by introducing bevels 129 on the corresponding joining surfaces 121, 123 and 122, 124, respectively. During the pressing process when connecting upper piston part 111 and lower piston part 112, the narrowings are filled with material that exits out of the weld seams at the side. In FIGS. 7 and 8, it can be seen that after upper piston part 111 and lower piston part 112 are connected, no beads are present in the region of the weld seams, but rather, an extensively smooth surface has been formed.

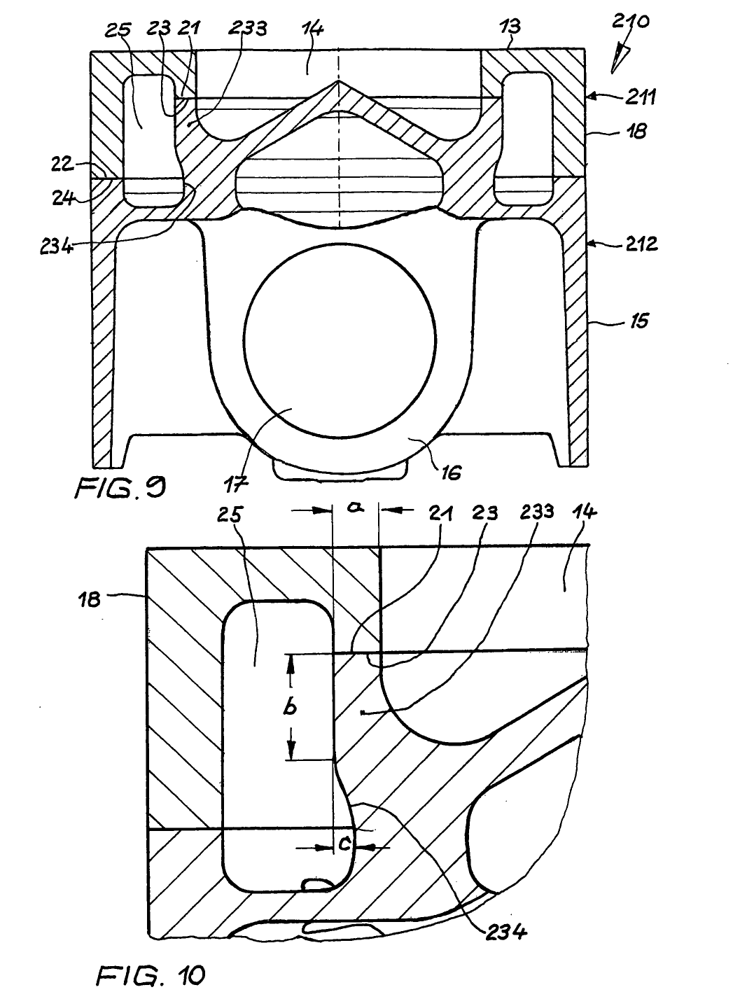

FIGS. 9 and 10 show another exemplary embodiment of a piston 210 according to the invention. The piston 210 essentially corresponds to the piston 10 according to FIGS. 1 to 4, so that reference is made to the above description in this regard. The same reference symbols were used for structures that agree with one another.

The piston 210 is composed of an upper piston part 211 and a lower piston part 212 that can be produced, for example, from a steel material or a cast iron material, for example by means of casting or forging. The piston 210 has a piston crown 13 having a combustion bowl 14, whereby piston crown 13 and combustion bowl 14 are formed partly by the upper piston part 11 and partly by the lower piston part 12. The top land and ring grooves along the outer wall region 18 were not shown, for the sake of clarity. The lower piston part 12 has a piston skirt 15 and piston pins 16 with pin bores 17 for accommodating a piston pin (not shown).

The upper piston part 211 has an inner joining surface 21 and an outer joining surface 22. The inner joining surface 21 is configured in a ring-shaped, circumferential manner in the region of the combustion bowl 14. The outer joining surface 22 is configured below the wall region 18 in the exemplary embodiment.

The lower piston part 212 also has an inner joining surface 23 and an outer joining surface 24. The inner joining surface 23 is configured in a ring-shaped, circumferential manner in the region of the combustion bowl 14, corresponding to the inner joining surface 22 of the upper piston part 211. In the exemplary embodiment, the outer joining surface 24 is configured as an extension of the piston skirt 15. The inner joining surfaces 21, 23 of the upper piston part 211 and of the lower piston part 212, respectively, are disposed offset from the outer joining surfaces 22, 24 of the upper piston part 11 and of the lower piston part 12, respectively, in the exemplary embodiment. The upper piston part 211 and the lower piston part 212 form a circumferential cooling channel 15.

The inner joining surfaces 21, 23 of upper piston part 211 and lower piston part 212, respectively, have a predetermined width a. The inner joining surface 23 of the lower piston part 212 is formed by a circumferential support element 233. The support element 233 has an axial length b that amounts to at least one and a half times the width a of the inner joining surfaces 21, 23: b≧1.5*a. The support element 233 delimits the cooling channel 25, on the one hand, and the combustion bowl 14, on the other hand. A constriction 234 on the cooling channel side is provided below the support element 233. The depth c of the constriction 234 amounts to at most 0.8 times the width a of the inner support surfaces 21, 23: c≦0.8*a.

This structure guarantees the stability of the piston 210 according to the invention, and, at the same time, the slimmest possible configuration of the support surfaces 21, 23 as well as of the support element 234, in order to obtain an optimal pressure welding connection.

Accordingly, while only a few embodiments of the present invention have been shown and described, it is obvious that many changes and modifications may be made thereunto without departing from the spirit and scope of the invention.

What is claimed is:

1. A method for the production of a piston for an internal combustion engine, comprising the following steps:
a) producing an upper piston part having at least one joining surface,
b) producing, a lower piston part having at least one joining surface,
c) producing a direct contact between the at least one joining surface of the upper piston part and the at least one joining surface of the lower piston part,
d) heating the upper piston part and the lower piston part by induction or by a direct flow of current over the joining surfaces in a region of the joining surfaces that have been brought into direct contact,
e) connecting upper piston part and lower piston part with one another to produce a piston, by means of a pressing process, and machining the piston to finish the piston.

2. The method according to claim 1, wherein a narrowing is provided in a region of at least one of the joining surfaces of the upper and lower piston parts, said narrowing being filled up, in step e), with material of upper piston part or lower piston part, respectively.

3. The method according to claim 2, wherein the narrowing is configured as a groove, notch, or constriction.

4. The method according to claim 1, wherein at least one of step d) and step e) is carried out in an ambient atmosphere.

5. The method according to claim 1, wherein in step e), the pressing process is combined with a rotating process.

6. The method according to claim 1, wherein the upper piston part has a combustion bowl as well as an inner and an outer joining surface, wherein the lower piston part has an inner and an outer joining surface, and wherein a circumferential cooling channel is formed by the upper piston part and lower piston part.

7. The method according to claim 6, wherein the inner and outer joining surfaces of the upper piston part and the lower piston part are disposed in a same plane or in at least two different planes.

8. The method according to claim 1, wherein at least one of the upper piston part and the lower piston part are produced from a steel material or a cast iron material.

9. The method according to claim 1, wherein at least one of the upper piston part and lower piston part are produced as a cast or forged part.

10. A piston for an internal combustion engine produced according to the method of claim 1.

11. A piston for an internal combustion engine, comprising:
an upper piston part having a combustion bowl and inner and outer joining surfaces;
a lower piston part having inner and outer joining surfaces, wherein the upper piston part and lower piston part form a circumferential cooling channel when the inner and outer joining surfaces of the upper piston part are joined with the inner and outer joining surfaces of the lower piston part respectively,
wherein the inner joining surfaces have a predetermined width (a), the inner joining surface of the lower piston part is formed by a circumferential support element, which has an axial length (b), with b≧1.5*a, and wherein a circumferential constriction on a cooling channel side having a depth (c), with c≦0.8*a, is provided below the circumferential support element.

12. The piston according to claim 11, wherein the constriction extends all the way to the bottom of the cooling channel.

13. The piston according to claim 11, wherein the inner and outer joining surfaces of the upper piston part and lower piston part, respectively, are disposed in the same plane or in at least two different planes.

14. The piston according to claim 11, wherein at least one of the upper and lower piston parts is produced from a steel material or a cast iron material.

15. The piston according to claim 11, wherein at least one of the upper and lower piston parts is produced as a cast or forged part.
